(19) United States
(12) Patent Application Publication
(10) Pub. No.: US 2026/0004410 A1
(43) Pub. Date: Jan. 1, 2026

(54) REAL-TIME SELFIE PERSPECTIVE UNDISTORTION ON MOBILES BY IM2IM TRANSLATION

(71) Applicant: Snap Inc., Santa Monica, CA (US)

(72) Inventors: Jian Wang, West New York, NJ (US); Haiwei Chen, Temple City, CA (US); Sizhuo Ma, Madison, WI (US); Gurunandan Krishnan Gorumkonda, Kirkland, WA (US)

(21) Appl. No.: 18/759,111

(22) Filed: Jun. 28, 2024

(51) Int. Cl. G06T 5/80; G06T 3/18; G06T 15/20; G06T 17/00

(52) U.S. Cl. CPC G06T 5/80; G06T 3/18; G06T 15/20; G06T 17/00; G06T 2200/04; G06T 2207/20081; G06T 2207/30201

(57) ABSTRACT

A network and method for correcting perspective distortion of a selfie image captured with a short camera-to-face distance by processing the selfie image and generating an undistorted selfie image appearing to be taken with a longer camera-to-face distance. A pre-trained three-dimension (3D) face generative adversarial network (GAN), such as an Efficient Geometry-aware three-dimensional (EG3D), is used to generate training data. The processing pipeline is composed of two parts, a warping network and a translation network, where the warping network outputs the backward warping guidance. Backwards warping is performed on the selfie image to generate a backwards warped image, and the backwards warped image is translated to generate a face image with details fixed to obtain the final image with reduced or no image distortion.

### TECHNICAL FIELD

The present subject matter relates to image processing.

### BACKGROUND

Electronic devices, such as smartphones, available today integrate cameras and processors configured to capture images and manipulate the captured images.

A selfie is a self-portrait photograph, typically taken with a camera of a portable electronic device such as a smartphone, which is usually held in the hand. Selfies are typically taken with the camera held at arm's length, as opposed to those taken by a selfie stick, using a self-timer or remote. Due to the limited distance imposed by the user's arm's length, such self-portrait photographs often appear distorted.

### BRIEF DESCRIPTION OF THE DRAWINGS

The drawing figures depict one or more implementations, by way of example only, not by way of limitations. In the figures, like reference numerals refer to the same or similar elements.

FIG. 1 is an illustration of an algorithm correcting perspective distortion of a selfie image;

FIG. 2 is a diagram illustrating perspective manipulation in face undistortion;

FIG. 3A is a flow diagram of an Efficient Geometry-aware three-dimensional (EG3D) taking in face latent code and camera parameters and generating a face image;

FIG. 3B is an illustration of images illustrating a training dataset procured by the EG3D of FIG. 3A;

FIG. 4A is a flow diagram of a perspective-aware detailed expression capture and animation (DECA) which outputs the camera parameters including z or dᵢₙ and 3d of the face;

FIG. 4B is an illustration of estimated 3d of the face using the perspective-aware DECA, showing the perspective-aware DECA result (right) is better than a common DECA result (middle);

FIG. 5 is a flow diagram of a network including the warping network, the translation network, the perspective-aware DECA, and the losses;

FIG. 6A and FIG. 6B are network architectures illustrating U-Net network architectures for performing the method;

FIG. 7A and FIG. 7B are flow diagrams illustrating a feature that separates the appearance and the structure to make the task easier by running run face parsing;

FIG. 8 is a flow diagram illustrating the perspective-aware DECA providing warping guidance after reconstructing the face shape;

FIG. 9 is a flow diagram illustrating the guidance from a previous frame's result to ensure temporal consistency;

FIG. 10 is a flow diagram illustrating additional information;

FIG. 11 is a flow diagram for online video where the EG3D keeps updating the 3D estimation of the face which provides guidance for the warping, and uses a previous frame's output as part of the input to ensure better temporal consistency;

FIG. 12 is a flow diagram for offline video, the warping to undistorting anchor frames first and then propagating the rest of the frames;

FIG. 13 a flow chart illustrating a method of backward warping of the input selfie image first and then image to image translation to generate an undistorted selfie image; and

FIG. 14 is a block diagram of electronic components of a mobile device configured for use with the method.

### DETAILED DESCRIPTION

A network and method for correcting perspective distortion of a selfie image captured with a short camera-to-face distance by processing the selfie image and generating an undistorted selfie image appearing to be taken with a longer camera-to-face distance. A pre-trained three-dimension (3D) face generative adversarial network (GAN), such as an EG3D, is used to generate training data. The pipeline of the selfie undistortion method includes two parts, a warping network and a translation network, where the warping network outputs the backward warping guidance. Backwards warping is performed on the selfie image to generate a backwards warped image, and the backwards warped image is translated to generate a face image with reduced or no image distortion.

Additional objects, advantages and novel features of the examples will be set forth in part in the description which follows, and in part will become apparent to those skilled in the art upon examination of the following and the accompanying drawings or may be learned by production or operation of the examples. The objects and advantages of the present subject matter may be realized and attained by means of the methodologies, instrumentalities and combinations particularly pointed out in the appended claims.

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and circuitry have been described at a relatively high-level, without detail, in order to avoid unnecessarily obscuring aspects of the present teachings.

The term “coupled” as used herein refers to any logical, optical, physical or electrical connection, link or the like by which signals or light produced or supplied by one system element are imparted to another coupled element. Unless described otherwise, coupled elements or devices are not necessarily directly connected to one another and may be separated by intermediate components, elements or communication media that may modify, manipulate or carry the light or signals.

Reference now is made in detail to the examples illustrated in the accompanying drawings and discussed below.

Perspective distortion refers to the unnatural appearance of faces when captured by perspective cameras at a close distance to the face, where regions such as ears, cheeks and jaws appear smaller, and a nose appears bigger compared to the normal appearance. Perspective face undistortion, therefore, is a technique that attempts to correct such unnatural appearance by re-rendering a face image in a further distance. As perspective distortion frequently appears in selfie photos taken by user's mobile phone cameras, undistortion techniques have great application values in recovering a more natural appearance from these images.

This disclosure includes a network application (network), such as a camera filter application, that is a lightweight and fast solution that accurately undistorts the captured face. The level of distortion present in the photo is estimated first and the re-rendering of the photo is conditioned on the level of distortion, allowing the undistorted face to appear faithful to one's natural appearance. The network is robust to different environment lighting, facial expression and image quality. The network is compatible with mobile applications that have limited processing power. Therefore, the network benefits most from design choices that prioritize both time and memory efficiency. The network is based on flow-based neural network methods that is at least 40× faster than previous approaches, achieving real-time performance even running on mobile phone, approaching the accuracy of the state-of-the-art undistortion approach and significantly more robust to in-the-wild photos.

The network is based on the following three design choices: 1) A facial distortion dataset is procured by utilizing an EG3D, a 3D face GAN that is trained on the abundant in-the-wild photos and models the underlying perspective 3D information of these photos. Although the encoded 3D geometry learnt by EG3D is partially inaccurate due to its unsupervised nature, this disclosure leverages its ability to simulate distortion effect on its learned face priors, and it is found that the distortion created therefore is realistic, as the operation to render a perspective close-up photo suffers little from the lack of geometric accuracy. 2) Several key designs are adjusted in the warping-based approach. Firstly, the forward warping formulation is replaced with a backward warping. This change effectively allows the network to be fully differentiable and can be trained end-to-end. Moreover, it enables training the flow network in an unsupervised manner, thus fully capitalizing the procured EG3D dataset. Secondly, as backward mapping ensures value assignment to every pixel in the warped image, the flow network creates an image without missing regions, therefore removing the need for an additional image completion module. 3) The warped image is further refined by an image translation network that not only recovers high frequency details from information loss in the warping process, it also inpaints facial regions, such as the ears and the cheeks, that are oftentimes partially occluded in the distorted face images. The entire network is trained with a conditional adversarial objective end-to-end to perform accurate face undistortion in real time.

Image-to-Image (Im2Im) is a fundamental computer vision task that has garnered significant attention in recent years due to its wide range of applications. One popular approach is the use of GANs, which have shown remarkable success in generating high-quality images from input data. Pix2Pix is a conditional image-to-image translation architecture that uses a conditional GAN objective combined with a reconstruction loss. The Pix2Pix model employs a conditional GAN to convert images from one domain to another, such as turning satellite images into maps. Cycle Generative Adversarial Network (CycleGAN) is an approach to training a deep convolutional neural network for image-to-image translation tasks. The Network learns mapping between input and output images using unpaired dataset. CycleGAN introduced the concept of cycle consistency to enable unpaired image translation. Pix2Pix and CycleGAN are available from Github, Inc. of San Francisco, California. Image-to-image translation has also found applications in medical imaging, where efforts like the U-Net architecture have been employed to perform tasks like image segmentation and image synthesis. U-Net is a deep learning architecture used for semantic segmentation tasks in image analysis. However, traditional Im2Im networks cannot generate ear regions. In order to generate the ears, this disclosure uses a cascaded design, a warping network and a translation network. Video-to-video translation (vid2vid) is a challenging task that requires preserving temporal consistency.

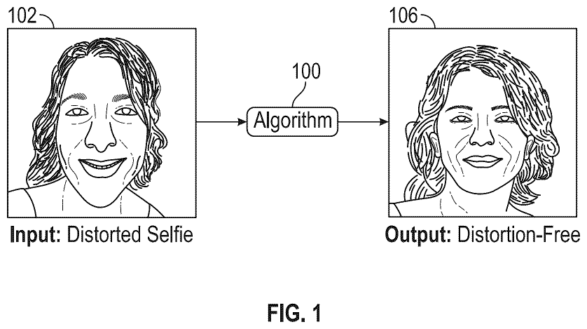

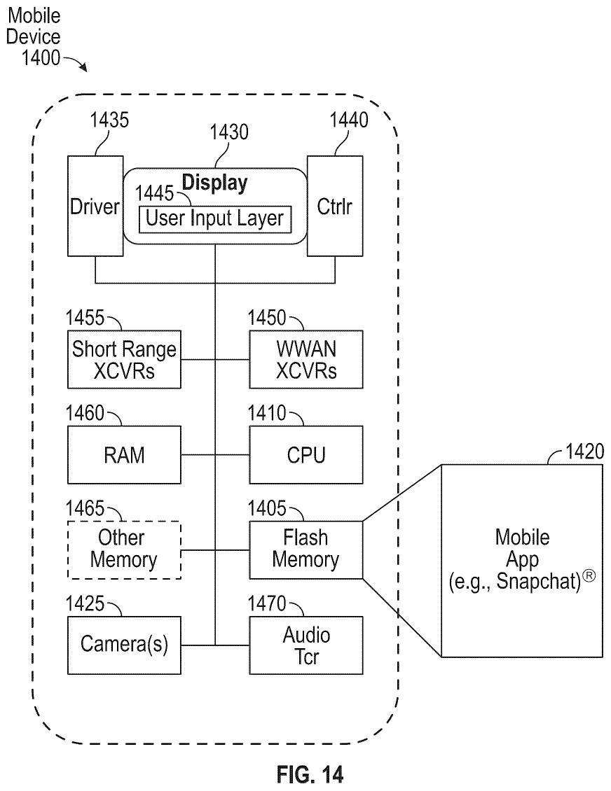

FIG. 1 is a flow diagram depicting an algorithm 100 image processing a selfie input image 102 captured by a front facing camera 1425 using a processor 1410 of a mobile device 1400, such as a smartphone (FIG. 14). Algorithm 100 receives selfie image 102 of a user's face captured at an arbitrary short camera-to-face distance. In one example, the short camera-to-face distance is 20-60 cm. Selfie image 102 is significantly distorted due to the short camera-to-face distance resulting in an abnormal face shape with a nose appearing larger than normal. The distorted selfie image 102 also fails to include the ears of the face. The processed and improved selfie image 106 generated by algorithm 100 has zero to minimal distortion of the face. Selfie image 106 appears to have been captured from a long camera-to-face distance. In an example, the long camera-to-face distance is greater than 1.5 meters. Selfie image 106 has a better face appearance than selfie image 102 where the face, nose, and other image features have no apparent distortion. Selfie image 106 also includes ears on the face, which may or may not have been present in the input selfie image 102. In an example, image types of a face other than a selfie are used as an input image 102. These image types include but are not limited to portrait photos or head shots.

Perspective distortion can be measured as the visual difference between a perspective image and an image that is orthographically projected at the same distance. Specifically, assuming a projection model whose field of view θ₀ covers a face at a calibrated distance d₀ this relates the field of view θ to the camera-to-face distance d by:

$$d tan \frac{θ}{2} = {d}_{0} tan \frac{{θ}_{0}}{2} \qquad Equation ( 1 )$$

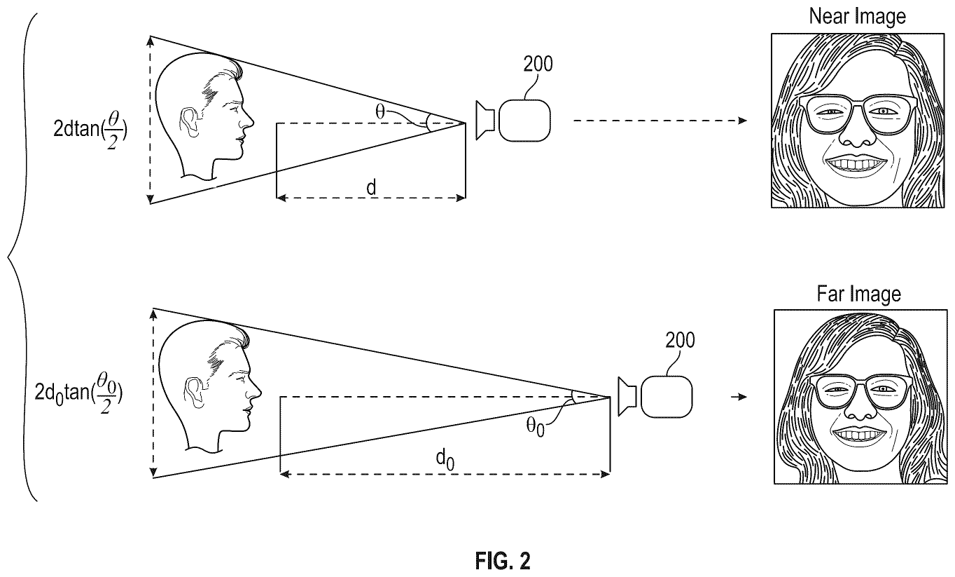

The above equation effectively keeps the area of the view plane fixed at the camera-to-face distance. Given an orthographically projected face image lₒᵣₜₕₒ, whose view plane has the same area as that of the perspective camera 200 at the face distance, the perspective distortion is measured by simply comparing the visual similarity between lₒᵣₜₕₒ and the perspective image Iₚᵣₒⱼ(d) rendered at the camera-to-face distance d as shown in FIG. 2. FIG. 2 is a diagram illustrating perspective manipulation in face undistortion. To undistort a close-up face image, the camera 200 is moved away from the face to a further distance of do while maintaining the scale of the captured face by adjusting the field-of-view θ₀ according to Equation 1.

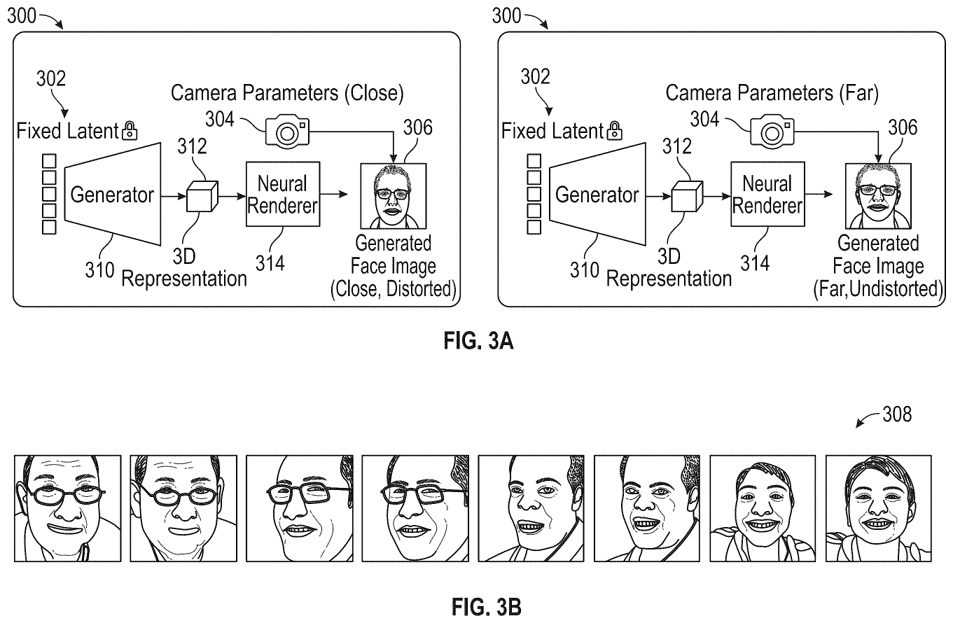

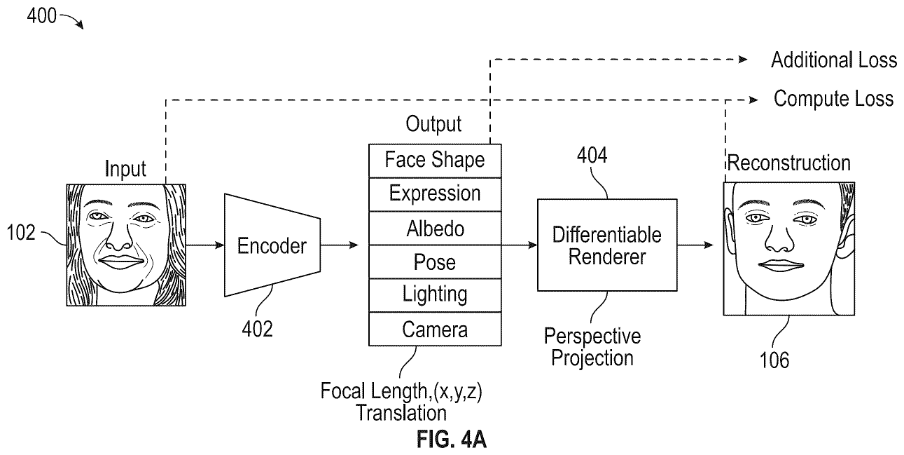

FIG. 3A is a flow diagram of an EG3D 300 taking in face latent code 302 and generating a triplane feature representation. The feature volume is rendered with a perspective camera 304 to create realistic face images 306. EG3D is a 3D face GAN pre-trained on a real face image dataset such as Flickr-Faces-HQ (FFHQ) and is leveraged to produce a large amount of distorted and undistorted faces. A distorted face is captured by setting the rendering camera 306 close to a human face (<1 meter). Face latent code 302 is input to a generator 310 and produces a 3D representation 312 of input selfie image 102. The 3D representation 312 is processed by a neural renderer 314 to generate the photorealistic face image 306.

In an example, to procure a training dataset 308 as shown in FIG. 3B, one-hundred thousand (100K) pairs of images are created with a near-face rendering (distorted face appearance) and distant rendering (natural face appearance) of the face associated with a random latent code z, while adjusting the field-of-view (FOV) of the far image based on the FOV of the near image. During data generation, the FOV, the camera angle for both the near and distant renderings, and the camera-to-face distance of the near-face rendering are randomized.

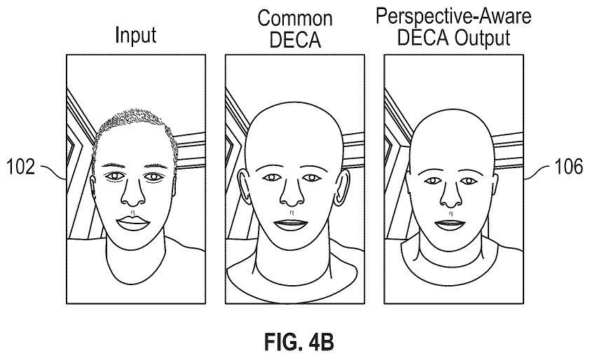

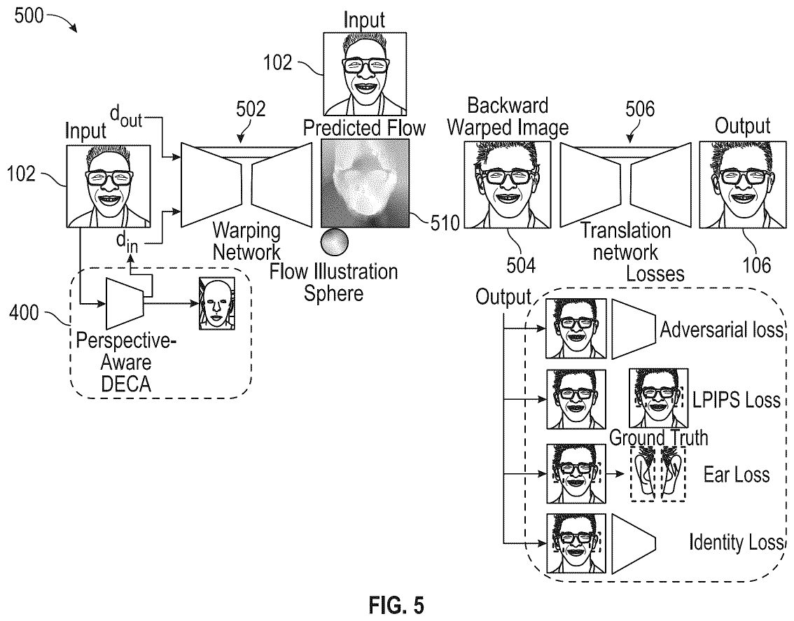

FIG. 4A is a flow diagram of the perspective-aware DECA 400 according to this disclosure used to estimate camera-to-face distance dᵢₙ and 3D parameters of a face in distorted input image 102. Perspective-aware DECA 400 includes an image encoder 402 and a differentiable renderer 404. Differentiable renderer 404 allows the gradients of 3D objects to be calculated and propagated through images. It also reduces the requirement of 3D data collection and annotation, while enabling higher success rates in various applications. Camera parameters dᵢₙ and dₒᵤₜ are denoted as the input and output camera-to-distance, respectively, where dᵢₙ is estimated by perspective-aware DECA 400, and dₒᵤₜ is specified by the user. An output of perspective-aware DECA 400 includes the camera parameters z or dᵢₙ and 3D representations of the face of input image 102. FIG. 4B illustrates an example of a distorted input image 102 and an image 106 that is a 2d projection of the correctly estimated 3d geometry of the face using perspective-aware DECA 400.

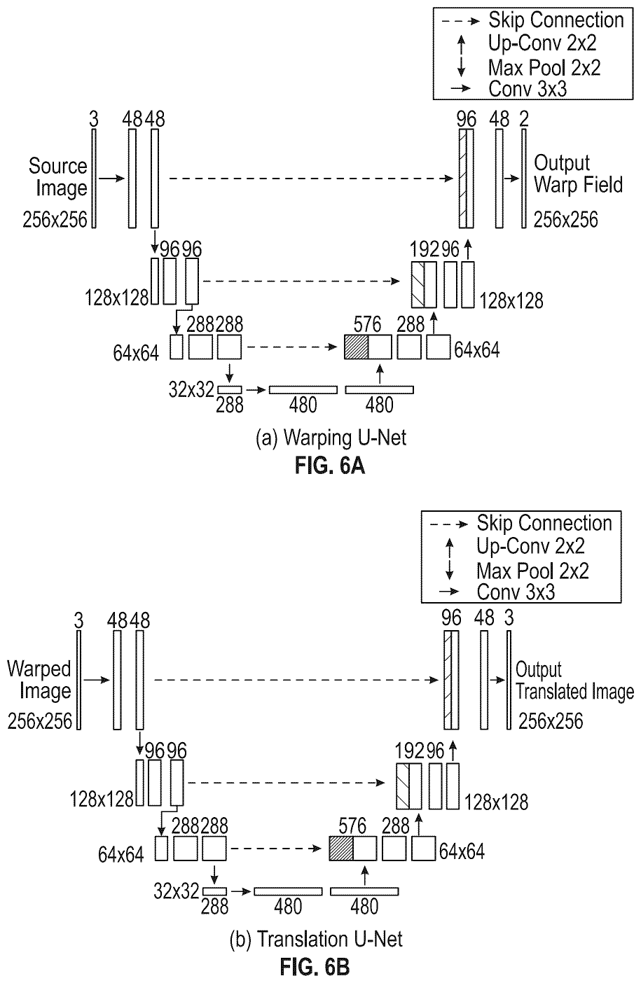

A flow diagram of a network 500 is shown in FIG. 5, wherein network 500 executes algorithm 100 and includes three main modules that are represented as convolutional neural networks (CNNs): a perspective-aware DECA 400, a backward image warping network 502, and an image translation network 506. Perspective-aware DECA 400 receives input image 102, and outputs dᵢₙ. Input image 102 is then input to the backward image warping network 502 that outputs backward warping flow map 510 to generate a backward flow and then backward warped accordingly to get the backward warped image 504. For each pixel in the backward warped image 504, a grid-sampled value is retrieved from the input image 102 based on the flow predicted on that pixel location. The backward warping is a surjective mapping, therefore ensuring value assignment to every pixel location in the warped results, although a pixel in the input image 102 can be mapped to several locations in the backward warped image 504. The differentiable nature of backward warping enables training of the backward image warping network 502 without direct flow supervision. Image translation network 506 processes the backward warped image 504 and creates the reconstructed and un-distorted output image 106.

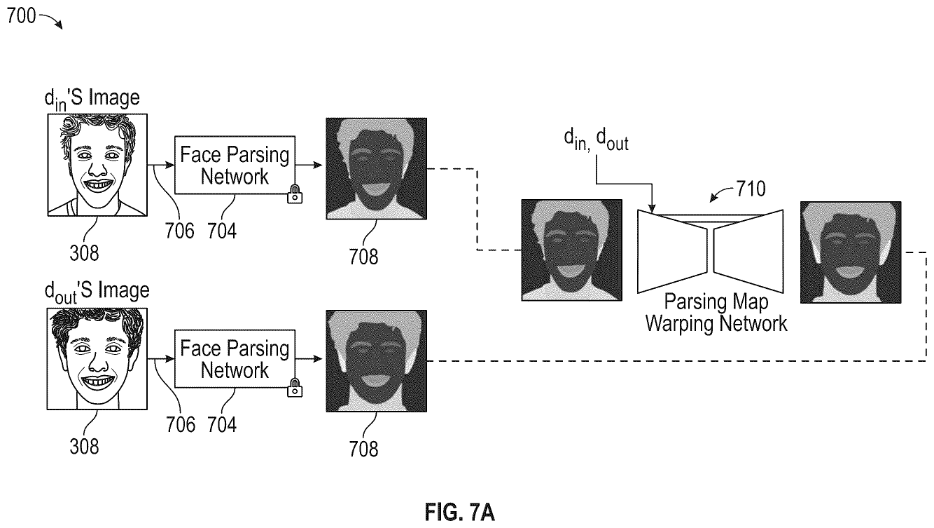

The image translation network 506, formulated as a U-Net with skipped connections, takes as input the backward warped image 504 and synthesizes its output to match with the ground truth undistorted image. Formally speaking, the image translation network 506 learns a mapping from the warped image domain to the natural image domain under a conditional GAN objective. Network architectures for all the modules 502 and 506 are U-Net as shown in FIG. 6A and FIG. 6B.

Network losses can be computed by denoting the input as x, ground truth as y, and the output as ŷ.

Adversarial Loss can be computed where the conditional GAN objective can be expressed as:

$${L}_{cGAN} ( G , D ) = {E}_{x , y} [ log D ( x , y ) + {E}_{x} log ( 1 - D ( x , G ( x ) ) ) ] , \qquad Equation ( 2 )$$

where G is the undistortion network that tries to synthesize an undistorted face image G(x) from a distorted input image x, and D is a convolutional discriminator that discriminates between the real undistorted image y and the generated undistorted image G(x), conditioning on the distorted image x.

Learned Perceptual Image Patch Similarity (LPIPS) Loss computes feature similarity in the feature space of a publicly available, pre-trained Visual Geometry Group (VGG) network. Specifically, the similarity is computed by:

$${ℒ}_{LPIPS} = {\sum }_{l} {w}_{l} \cdot \frac{1}{{H}_{l} {W}_{l} {C}_{l}} {\sum }_{h = 1}^{{H}_{l}} {\sum }_{w = 1}^{{W}_{l}} {\sum }_{c = 1}^{{C}_{l}} {( {{ϕ}_{l}^{c} ( \hat{y} )}_{hw} - {{ϕ}_{l}^{c} ( y )}_{hw} )}^{2} \qquad Equation ( 3 )$$

where:

$${{ϕ}_{l}^{c} ( \hat{y} )}_{hw} and {{ϕ}_{l}^{c} ( y )}_{hw}$$

are the feature values at channel c, position (h,w) in layer l of the pre-trained VGG network; Hₗ, Wₗ, Cₗ are the height, width, and number of channels of the feature maps at layer l, respectively; we are the weights for layer l, typically learned to optimize the assessment of perceptual similarity.

GAN loss for an ear is calculated using Equation 4.

$${ℒ}_{{GAN}_{ear}} = {𝔼}_{e ∼ {p}_{eardata}} log D ( e ) + {𝔼}_{x} log ( 1 - D ( {C}_{e} ( G ( x ) ) ) ) \qquad Equation ( 4 )$$

where Ce(·) is a cropping function to get the ear-only regions, D is a convolutional discriminator that discriminates between the real ears and the generated ears here.

Identity Preserving Loss is calculated using Equation 5.

$${ℒ}_{id} = {λ}_{id} {‖ η ( \hat{y} ) - η ( y ) ‖}_{1} \qquad Equation ( 5 )$$

where η represents face identity feature extractor.

Finally, the total loss is a linear combination of the above losses that can be obtained using Equation 6.

$$ℒ = {L}_{cGAN} + {λ}_{1} {ℒ}_{LPIPS} + {λ}_{2} {ℒ}_{{GAN}_{ear}} + {λ}_{3} {ℒ}_{id} \qquad Equation ( 6 )$$

### Perspective-Aware DECA

Instead of asking a network to directly regress the camera distance from the distorted input image 102, method 400 utilizes learned face priors and predicts camera parameters together with 3D Morphable Face Models (3DMM) parameters. While existing solutions such as DECA assumes a weak perspective projection model, it is replaced with perspective projection where the focal length and (x, y, z) camera translation are jointly regressed by an encoder 402, such as a Residential Network 50 (ResNet-50) which is a convolutional neural network (CNN). Perspective-aware DECA 400 serves two roles in this approach: (1) Predict the distance between the camera and the face (the predicted z value), and (2) predict the 3D shape of the face, which is used as a guidance for learning the warping. The original self-supervised regime with two dimension (2D) images and losses are not sufficient to train perspective-aware DECA 400. This is mainly because of the ambiguity between face shape and camera distance, i.e., the same image can be the result of a flat face at a close distance, or a protruding face at a long distance. This is solved by direct supervision with 3D face data, which is obtained through high-fidelity face scanning and synthesis. In addition to the 2D losses from DECA, a mean square error (MSE) loss is added on the predicted camera-face distance to resolve the aforementioned ambiguity through direct supervision. Specifically, the loss is computed on the reciprocal of the distance, as the pixel difference introduced by perspective distortion is inversely proportional to the distance. Computing the loss on the reciprocal penalizes more on the shorter distances, which is exactly the range of interest. Perspective-aware DECA 400 learns to regress this distance in a generalizable way because in reality extremely flat or protruding face is unlikely to exist, which provides a cue to predict the distance.

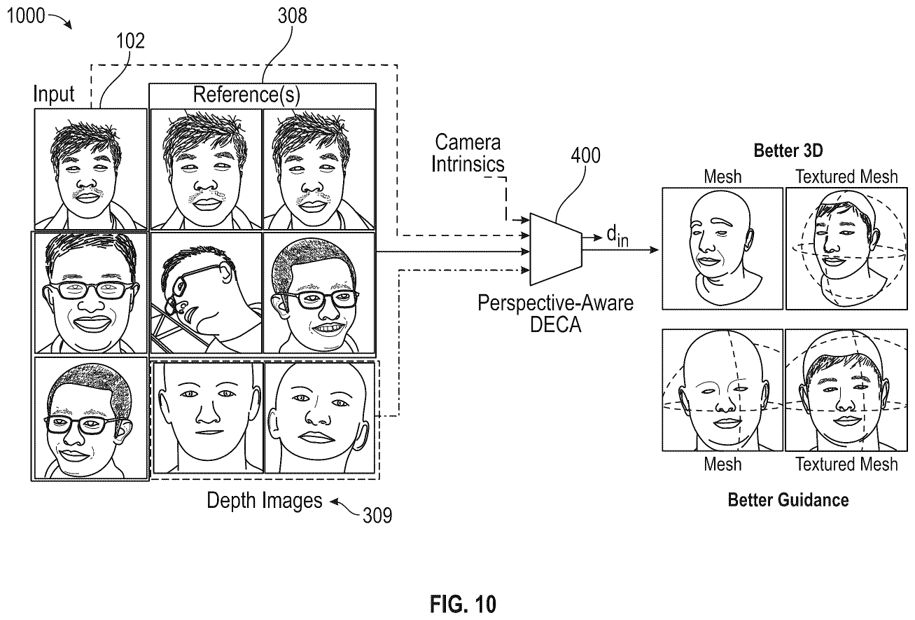

When extra reference images 308 are available as input, the perspective-aware DECA 400 is extended to multiple images, such as 7 images as shown in FIG. 10. Specifically, the perspective-aware DECA 400 shown in FIG. 10 is used to predict the shape parameters (together with albedo, lighting, pose, expression and camera parameters) for each input image 406 as shown in FIG. 4A. Various strategies are then adopted to fuse the predictions together, depending on the computational budget. One strategy predicts a confidence value for each shape parameter prediction by using the confidence to combine the shape parameters using weighted average as the final estimate. Another strategy uses a shallow Multilayer Perceptron (MLP) to combine the predicted shape parameters to get the final estimate. Another strategy solves an optimization problem where the goal is to minimize the image losses after differentiable rendering. The parameters to optimize are the face parameters (shared among all images) and camera parameters (different for each image).

It is also possible to take depth images 309 as input. After predicting the face and camera parameters, differentiable rendering is used to render a depth map of the face. Then an L1 or L2 loss is computed between the input depth map and the predicted depth map, either over all pixels on the face or only the facial landmarks. L1 loss is used to minimize the error which is the sum of the all the absolute differences between the true value and the predicted value. L2 loss is used to minimize the error which is the sum of the all the squared differences between the true value and the predicted value.

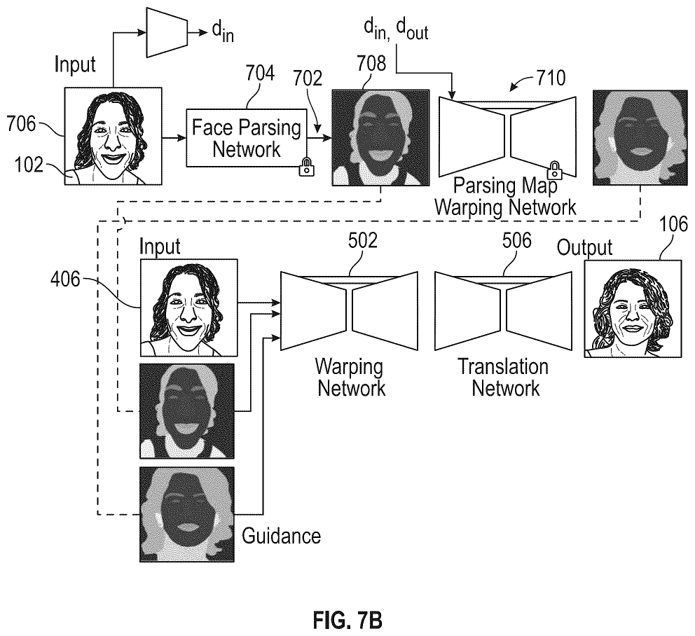

FIG. 7A and FIG. 7B are flow diagrams 700 and 702, respectively, illustrating a key feature that separates the appearance and the structure to make the task easier by running face parsing (or face landmark detection) using a face parsing network 704 on training pairs of images 306 from training dataset 308 provided at inputs 706. The face parsing results are parsing maps 708 which do not include the ear regions. Warping of the parsing maps 708 is learned from training parsing map images. The warped parsing map 708 includes the ear region and is used to guide the generation of the output.

Net++: warping is guided by the warped parsing maps 708, since parsing map warping is easier to learn by a network than image warping because texture is separated out (more specifically, in an image warping task, face appearance and face structure are mixed/entangled; in parsing map warping task, they are disentangled, and the network only needs to learn the warping from one parsing map to another parsing map). A parsing map warping network 710 is first trained using parsing maps 708 as shown in FIG. 7A. The parsing map warping network 710 is used on distorted input images 102 to provide warping guidance for the warping network 502 and lastly translation network 506 is used to refine the warped image to get the final undistorted output images 106 as shown in FIG. 7B.

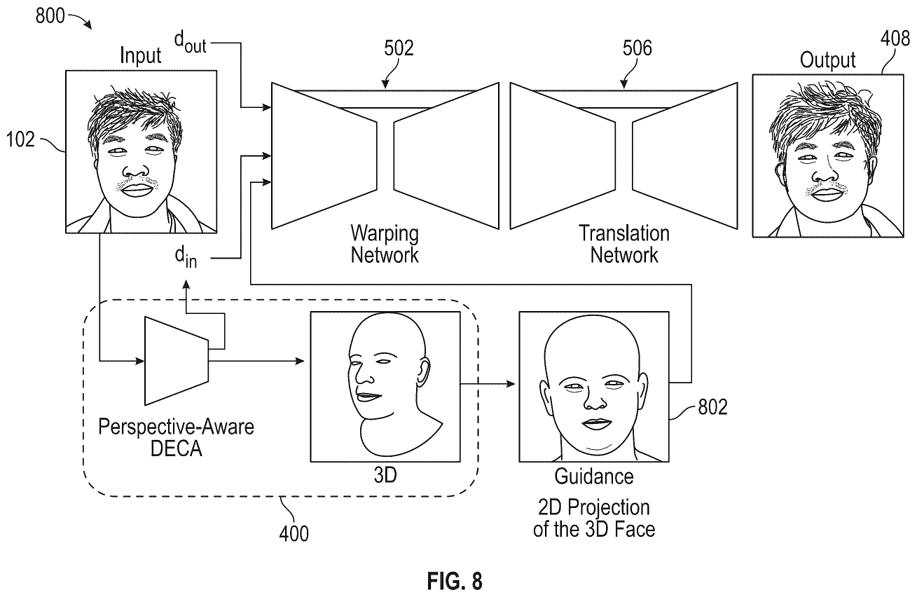

FIG. 8 is a flow diagram 800 illustrating perspective-aware DECA 400 providing warping guidance 802 after reconstructing the face shape to produce an output 408. The face model is rendered at the desired distance which provides the warping guidance. Net++: warping is guided by 2D projection of the 3D face.

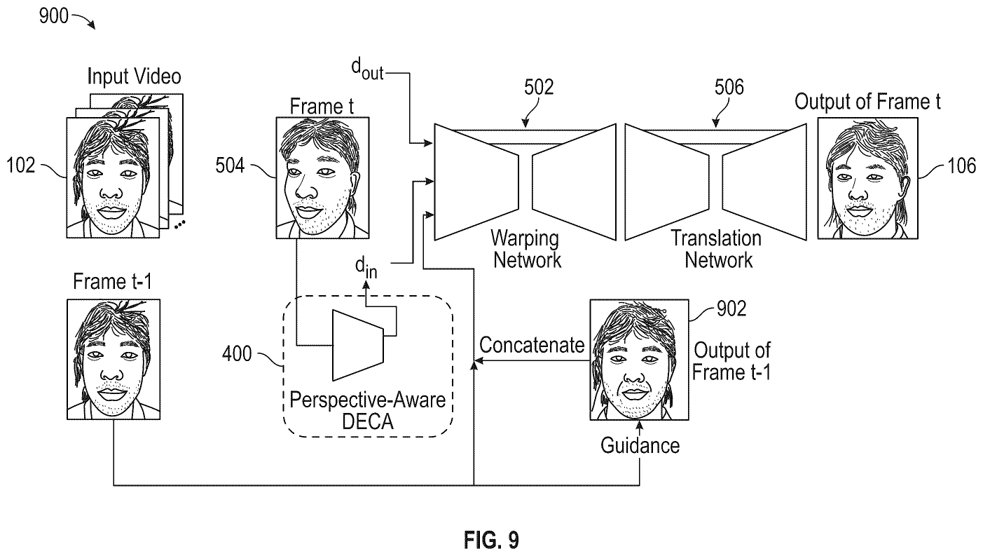

FIG. 9 is a flow diagram 900 illustrating perspective-aware DECA 400 providing guidance 902 from a previous frame's result to ensure temporal consistency. Net++: warping guided by previous frame's result to ensure temporal consistency.

FIG. 10 is a flow diagram 1000 illustrating additional information including (1) camera intrinsics (like focal length, center of projection), (2) n (=1 or >1) distorted/undistorted reference image(s) which are uploaded by the user or the beginning frames of a video, (3) n (=1 or >1) depth map(s) can help estimate better 3D face as previously described which can hence provide better warping guidance.

Optionally, the projection can be done with a learned albedo map (which defines the diffuse color of an object, i.e., the color that it would appear to have in bright, evenly-distributed light) and diffusive lighting, or back-project the input image as a texture to the face model and project it to the new view. Although this does not give a photorealistic rendering of the person (as shown in the bottom right corner of FIG. 10), it provides a strong guidance for learning the warping. Additional information aids in better estimation of dᵢₙ and 3D face, thereby generating improved guidance.

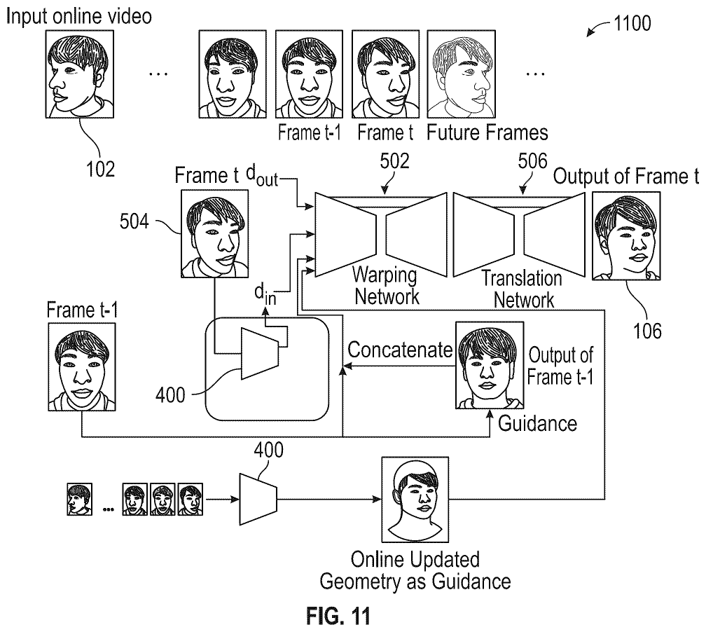

FIG. 11 is a flow diagram 1100 for online video where perspective-aware DEDA 400 continuously updates the 3D estimation of the face, which provides guidance for the warping, and uses a previous frame's output as part of the input to provide better temporal consistency.

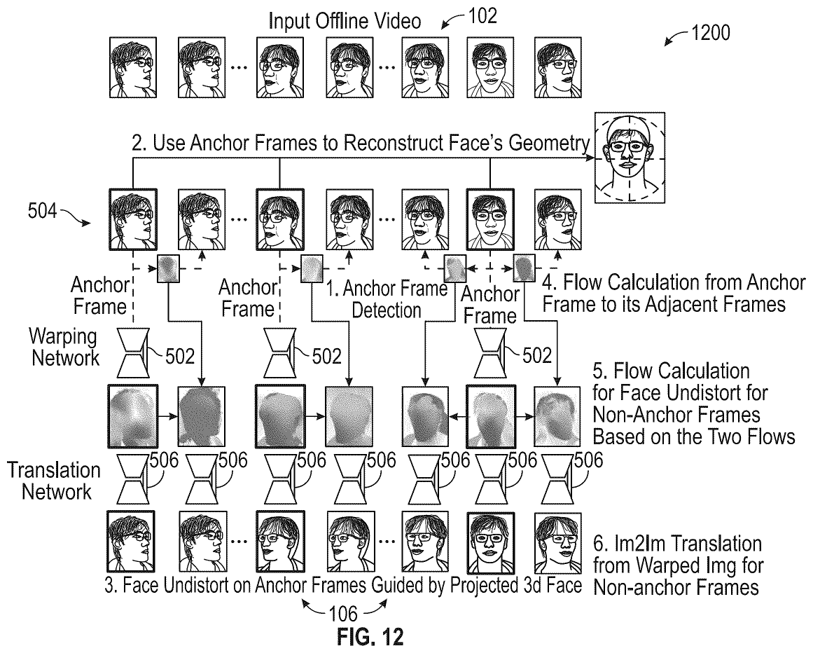

FIG. 12 is a flow diagram 1200 for offline video that undistorts a few anchor frames and interpolates the flow fields between anchor frame and non-anchor frames. In this way, the computation is minimized and the temporal consistency is better guaranteed. More specifically, given all the video frames, (1) anchor frames are detected which are the cluster centers of all the frames, (2) all anchor frames are used to reconstruct face's 3D geometry, (3) face undistort is done on anchor frames guided by the 2D projection of the 3D face during which the warping flow maps are intermediate results, (4) calculating the flow maps from anchor frames to its adjacent frames, (5) calculating the face undistort-warping flow maps for non-anchor frames based on the two flow maps: face undistort-warping flow maps of anchor frames, flow maps among the original (input) frames, (6) running the translation network on the warped image for non-anchor frames to get the results.

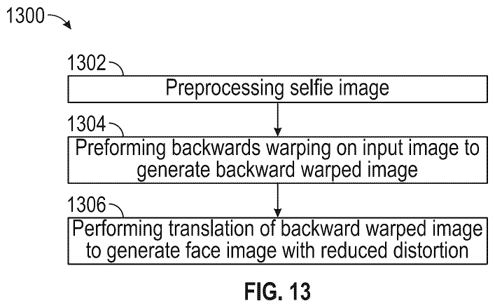

FIG. 13 a flow chart 1300 illustrating a method of algorithm 100 of correcting perspective distortion of selfie image 102 and generating undistorted selfie image 106. The method is performed by processor 1410 described with reference to FIG. 5.

At block 1302, the system receives input image 102 and outputs the crop of the face in selfie image 102. In an example, selfie image 102 is captured by a user with a front camera 1425 of a smart phone 1400 (FIG. 14). In an example, selfie image 102 is taken at a camera-to-face distance between 20 cm and 60 cm.

At block 1304, image warping network 502 outputs a backward warping flow map 510 and then backward warping is performed on the input image 102 to generate a backward warped image 504. For each pixel in the backward warped image 504, a grid-sampled value is retrieved from the input image 102 based on the flow predicted on that pixel location. The backward warping is a surjective mapping, therefore ensuring value assignment to every pixel location in the warped results, although a pixel in the input image 102 can be mapped to several locations in the backward warped image 504. The differentiable nature of backward warping enables training of the backward image warping network 502 without direct flow supervision. The perspective-aware DECA 400 is used to output the camera-to-face distance, which is input to image warping network 502. Another input to image warping network 502 is the desired camera-to-face distance. The image warping network 502 is formulated as a U-Net with skipped connections.

At block 1306, image translation network 506 performs translation of the backward warped image 504 to generate an improved and undistorted image 106 of the face. Image translation network 506 processes the backward warped image 504 and creates the reconstructed and undistorted output image 106. Image translation network 506, formulated as a U-Net with skipped connections, takes as input the backward warped image 504 and synthesizes its output to match with the ground truth undistorted image. Formally speaking, the image translation network 506 learns a mapping from the warped image domain to the natural image domain under a conditional GAN objective.

As shown in FIG. 14, the mobile device 1400 includes at least one digital transceiver (XCVR) 1450, shown as WWAN (Wireless Wide Area Network) XCVRs, for digital wireless communications via a wide-area wireless mobile communication network. The mobile device 1400 also may include additional digital or analog transceivers, such as short-range transceivers (XCVRs) 1455 for short-range network communication, such as via NFC, VLC, DECT, ZigBee, BLUETOOTH®, or WI-FI®. For example, short range XCVRs 1455 may take the form of any available two-way wireless local area network (WLAN) transceiver of a type that is compatible with one or more standard protocols of communication implemented in wireless local area networks, such as one of the WI-FI® standards under IEEE 802.11.

To generate location coordinates for positioning of the mobile device 1400, the mobile device 1400 also may include a global positioning system (GPS) receiver. Alternatively, or additionally, the mobile device 1400 may utilize either or both the short range XCVRs 1455 and WWAN XCVRs 1450 for generating location coordinates for positioning. For example, cellular network, WI-FI®, or BLUETOOTH® based positioning systems may generate very accurate location coordinates, particularly when used in combination. Such location coordinates may be transmitted to the mobile device 1400 over one or more network connections via XCVRs 1450, 1455.

The transceivers 1450, 1455 (i.e., the network communication interface) may conform to one or more of the various digital wireless communication standards utilized by modern mobile networks. Examples of WWAN transceivers 1450 include (but are not limited to) transceivers configured to operate in accordance with Code Division Multiple Access (CDMA) and 3rd Generation Partnership Project (3GPP) network technologies including, for example and without limitation, 3GPP type 2 (or 3GPP2) and LTE, at times referred to as “4G.” The transceivers may also incorporate broadband cellular network technologies referred to as “5G.” For example, the transceivers 1450, 1455 provide two-way wireless communication of information including digitized audio signals, still image and video signals, web page information for display as well as web-related inputs, and various types of mobile message communications to/from the mobile device 1400.

The mobile device 1400 may further include a microprocessor that functions as the central processing unit (CPU) 1410. A processor is a circuit having elements structured and arranged to perform one or more processing functions, typically various data processing functions. Although discrete logic components could be used, the examples utilize components forming a programmable CPU. A microprocessor for example includes one or more integrated circuit (IC) chips incorporating the electronic elements to perform the functions of the CPU 1410. The CPU 1410, for example, may be based on any known or available microprocessor architecture, such as a Reduced Instruction Set Computing (RISC) using an ARM architecture, as commonly used today in mobile devices and other portable electronic devices. Of course, other arrangements of processor circuitry may be used to form the CPU 1410 or processor hardware in smartphone, laptop computer, and tablet.

The CPU 1410 serves as a programmable host controller for the mobile device 1400 by configuring the mobile device 1400 to perform various operations, for example, in accordance with instructions or programming executable by CPU 1410. For example, such operations may include various general operations of the mobile device 1400, as well as operations related to the programming for messaging apps and AR camera applications on the mobile device 1400. Although a processor may be configured by use of hardwired logic, typical processors in mobile devices are general processing circuits configured by execution of programming.

The mobile device 1400 further includes a memory or storage system, for storing programming and data. In the example shown in FIG. 14, the memory system may include flash memory 1405, a random-access memory (RAM) 1460, and other memory components 1465, as needed. The RAM 1460 may serve as short-term storage for instructions and data being handled by the CPU 1410, e.g., as a working data processing memory. The flash memory 1405 typically provides longer-term storage. The mobile device 1400 also includes a display driver 1435, a display controller 1440, and a user input layer 1445.

Hence, in the example of mobile device 1400, the flash memory 1405 may be used to store programming or instructions for execution by the CPU 1410. Depending on the type of device, the mobile device 1400 stores and runs a mobile operating system through which specific applications are executed. Examples of mobile operating systems include Google Android, Apple IOS (for iPhone or iPad devices), Windows Mobile, Amazon Fire OS (Operating System), RIM BlackBerry OS, or the like.

The mobile device 1400 may include an audio transceiver 1470 that may receive audio signals from the environment via a microphone (not shown) and provide audio output via a speaker (not shown). Audio signals may be coupled with video signals and other messages by a messaging application or social media application implemented on the mobile device 1400. The mobile device 1400 may execute mobile application software 1420 such as SNAPCHAT® available from Snap, Inc. of Santa Monica, CA that is loaded into flash memory 1405.

Mobile device 1400 is configured to run algorithm 100. In one example, front facing camera 1425 of mobile device 1400 is used to capture selfie input image 102 which is distorted due to a short camera-to-face distance. CPU 1410 runs algorithm 100 stored in memory 1405 or 1465 of mobile device 1400 to output improved selfie image 106. Distortion in the forehead, nose, cheek bones, jaw line, chin, lips, eyes, eyebrows, ears, hair, and neck of the face is improved in processed selfie image 106 as compared to selfie image 102. In one example, a user manually selects a camera-to-face distance dₒᵤₜ for processed selfie image 106. The selection of the camera-to-face distance dₒᵤₜ may be done with a manual sliding user interface displayed on display 1430 of device 1400, or it may be a discrete selection presented by a user interface displayed on the display 1430. Algorithm 100 automatically adjusts the focal length of the processed selfie image 106 to keep pupillary distance the same as selfie image 102.

Techniques described herein also may be used with one or more of the computer systems described herein or with one or more other systems. For example, the various procedures described herein may be implemented with hardware or software, or a combination of both. For example, at least one of the processor, memory, storage, output device(s), input device(s), or communication connections discussed below can each be at least a portion of one or more hardware components. Dedicated hardware logic components can be constructed to implement at least a portion of one or more of the techniques described herein. For example, and without limitation, such hardware logic components may include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Applications that may include the apparatus and systems of various aspects can broadly include a variety of electronic and computer systems. Techniques may be implemented using two or more specific interconnected hardware modules or devices with related control and data signals that can be communicated between and through the modules, or as portions of an ASIC. Additionally, the techniques described herein may be implemented by software programs executable by a computer system. As an example, implementations can include distributed processing, component/object distributed processing, and parallel processing. Moreover, virtual computer system processing can be constructed to implement one or more of the techniques or functionalities, as described herein.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” or any other variation thereof, are intended to cover a non-exclusive inclusion, such that a process, method, article, or apparatus that comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element.

Unless otherwise stated, any and all measurements, values, ratings, positions, magnitudes, sizes, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like may vary by as much as ±10% from the stated amount.

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected lies in less than all features of any single disclosed example. Thus, the following claims are hereby incorporated into the Detailed Description, with each claim standing on its own as a separately claimed subject matter.

While the foregoing has described what are considered to be the best mode and other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

What is claimed is:

1. A method of image processing using a network, comprising the steps of:
processing an input image including a face;
generating a backward warping map;
performing backwards warping on the input image using the backward warping map to generate a backward warped image; and
performing translation of the backward warped image to generate an improved image of the face with reduced face distortion by setting a longer camera-to-face distance.

2. The method of claim 1, wherein a perspective-aware detailed expression capture and animation (DECA) generates output camera parameters z or dᵢₙ and 3D representations of the face of the input image, wherein dᵢₙ is a camera-to-face distance of the input image.

3. The method of claim 2, wherein the perspective-aware DECA includes an image encoder and a differentiable renderer, wherein the differentiable renderer utilizes a perspective projection, and calculates gradients of 3D objects and allows the gradients of 3D objects to be propagated through images.

4. The method of claim 1, wherein an image warping network receives the input image and generates the backward warping map, wherein for each pixel in the backward warped image a grid-sampled value is retrieved from the input image based on a flow predicted on that pixel location.

5. The method of claim 4, wherein the warping network accepts information to guide the backward warping, the information is selected from the group of: a warped face parsing map, a 2d projection of a 3d face, or a previous frame result.

6. The method of claim 4, wherein the backward warping enables training of the warping network without direct flow supervision.

7. The method of claim 4, wherein the backward warped image is refined by an image translation network to generate a final output image that has less distortion than the input image.

8. The method of claim 1, further comprising performing offline video processing by undistorting anchor frames and then propagating the undistortion to additional frames to reduce computation and provide temporal consistency.

9. A network configured to:
process an input image including a face;
generate a backward warping map;
perform backwards warping on the input image using the backward warping map to generate a backward warped image; and
perform translation of the backward warped image to generate an improved image of the face with reduced face distortion by setting a longer camera-to-face distance.

10. The network of claim 9, wherein a perspective-aware detailed expression capture and animation (DECA) is configured to generate output camera parameters z or dᵢₙ and 3D representations of the face of the input image, wherein dᵢₙ is a camera-to-face distance of the input image.

11. The network of claim 10, wherein the perspective-aware DECA includes an image encoder and a differentiable renderer, wherein the differentiable renderer is configured to utilize perspective projection and is configured to calculate gradients of 3D objects and allow the gradients of 3D objects to be propagated through images.

12. The network of claim 9, wherein an image warping network is configured to receive the input image and generate the backward warping map, wherein for each pixel in the backward warped image a grid-sampled value is retrieved from the input image based on a flow predicted on that pixel location.

13. The network of claim 12, wherein the warping network is configured to accept information to guide the backward warping, the information is selected from the group of: a warped face parsing map, a 2d projection of a 3d face, or a previous frame result.

14. The network of claim 12, wherein the backward warping is configured to enable training of the warping network without direct flow supervision.

15. The network of claim 12, wherein the backward warped image is configured to be refined by an image translation network to generate a final output image that has less distortion than the input image.

16. The network of claim 12, further configured to perform offline video processing by undistorting anchor frames and then propagating the undistortion to the additional frames to reduce computation and provide temporal consistency.

17. A non-transitory computer readable storage medium that stores instructions that when executed by a processor cause the processor to process an image using a method by performing the steps of:
processing an input image including a face;
generating a backward warping map;
performing backwards warping on the input image to generate a backward warped image; and
performing translation of the backward warped image to generate an improved image of the face with reduced face distortion by setting a longer camera-to-face distance.

18. The non-transitory computer readable storage medium of claim 17 wherein the method includes a perspective-aware detailed expression capture and animation (DECA) estimating a camera-to-face distance dᵢₙ and 3D parameters of the face in the input image.

19. The non-transitory computer readable storage medium of claim 18 wherein the perspective-aware DECA includes an image encoder and a differentiable renderer, wherein the differentiable renderer utilizes a perspective projection, and calculates gradients of 3D objects and allows the gradients of 3D objects to be propagated through images.

20. The non-transitory computer readable storage medium of claim 17 wherein an image warping network receives the input image and generates the backward warping map, wherein for each pixel in the backward warped image a grid-sampled value is retrieved from the input image based on a flow predicted on that pixel location, and then an image to image translation network is applied to refine the backward warped image to fix details and obtain a final output image.
